(19) United States
(12) Patent Application Publication
(10) Pub. No.: US 2012/0140628 A1
(43) Pub. Date: Jun. 7, 2012

(54) NETWORK COMMUNICATION NODE AND DATA TRANSMISSION METHOD THEREOF FOR USE IN POWER LINE COMMUNICATION NETWORK

(75) Inventor: Chi-Wen TENG, Sanchong City (TW)

(73) Assignee: INSTITUTE FOR INFORMATION INDUSTRY, Taipei (TW)

(21) Appl. No.: 12/977,636

(22) Filed: Dec. 23, 2010

(30) Foreign Application Priority Data
Dec. 7, 2010 (TW) 099142606

(51) Int. Cl. H04L 12/26

(52) U.S. Cl. 370/235

(57) ABSTRACT

A network communication node and a data transmission method thereof for use in a power line communication network are provided. The network communication node receives a broadcast message from a gateway, and determines whether the load of the power line communication network changes or not. The network communication node is capable of changing a route for transmitting the data dynamically according to the change of the load.

This application claims priority to Taiwan Patent Application No. 099142606 filed on Dec. 7, 2010, which is hereby incorporated by reference in its entirety.

### FIELD

The present invention relates to a network communication node and a data transmission method thereof for use in a power line communication (PLC) network. More particularly, the network communication node and the data transmission method thereof of the present invention are capable of dynamically changing a route path for transmitting data according to load of the PLC network.

### BACKGROUND

In order to meet demands for transmission of various kinds of information, a wide variety of heterogeneous networks have been developed, among which the most important one is the power line communication (PLC) network. To be more specific, the primary concept of the PLC network is that, information to be transmitted is digitalized and then transmitted through an existing power line. Transmitting a signal in this way is advantageous in that, no additional network wiring is needed; and moreover, the wide coverage of power lines is incomparable to other kinds of networks.

However, albeit of the aforesaid advantages, the PLC network still suffers from some limitations in terms of data transmission that are imposed by other factors. Specifically, prominent factors affecting the PLC network include: I. high noises generated when electrical apparatuses of the PLC network operate in the power lines; II. significant attenuation of carrier signals for carrying data when propagating through the power lines due to influence of the distance, resistance and shunting; and III. instability in transmission of the carrier signals due to the highly time-varying usage status of the PLC network. Consequently, if a route path for data transmission in the PLC network is determined in a conventional way (e.g., through route discovery or device discovery), then too much time and too many network resources will be wasted, making determination of the route path very inefficient.

Accordingly, an urgent need exists in the art to dynamically determine a route path in the PLC network to allow for real-time, efficient and correct data transmission.

### SUMMARY

To solve he aforesaid problem of the power line communication (PLC) network in determining a route path, an objective of the present invention is to provide a network communication node and a data transmission method thereof for use in a PLC network. The network communication node and the data transmission method thereof allow for efficient data transmission by dynamically changing a route path for data transmission according to a load of the PLC network.

To achieve the aforesaid objective, the present invention provides a data transmission method for a network communication node. The network communication node is for use in a PLC network. The PLC network comprises a gateway and the network communication node. The gateway is connected to the network communication node through a power line system. The data transmission method comprises the following steps of: (a) enabling the network communication node to receive a broadcast instruction from the gateway; (b) enabling the network communication node to determine a load change of the PLC network according to the broadcast instruction; (c) enabling the network communication node to determine at least one updated route path according to the load change; and (d) enabling the network communication node to transmit a communication data to another network communication node through the at least one updated route path.

To achieve the aforesaid objective, the present invention further provides a network communication node for use in a PLC network. The PLC network comprises a gateway and the network communication node. The gateway is connected to the network communication node through a power line system. The network communication node comprises a transceiver and a processing unit. The transceiver receives a broadcast instruction from the gateway. The processing unit determines a load change of the PLC network according to the broadcast instruction and determines at least one updated route path according to the load change. The transceiver transmits a communication data to another network communication node through the at least one updated route path.

With the technical features disclosed above, the network communication node of the present invention can determine whether the load of the PLC network changes; if the load changes, then the network communication node dynamically changes the route path for data transmission according to the change of the load.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a PLC network of a first embodiment of the present invention;

FIG. 1B is a schematic view of a network communication node of the first embodiment of the present invention;

FIG. 1C is a schematic view of a route table of the network communication node of the first embodiment of the present invention; and

FIG. 2 is a flowchart of a data transmission method of a second embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements not directly related to the present invention are omitted from depiction.

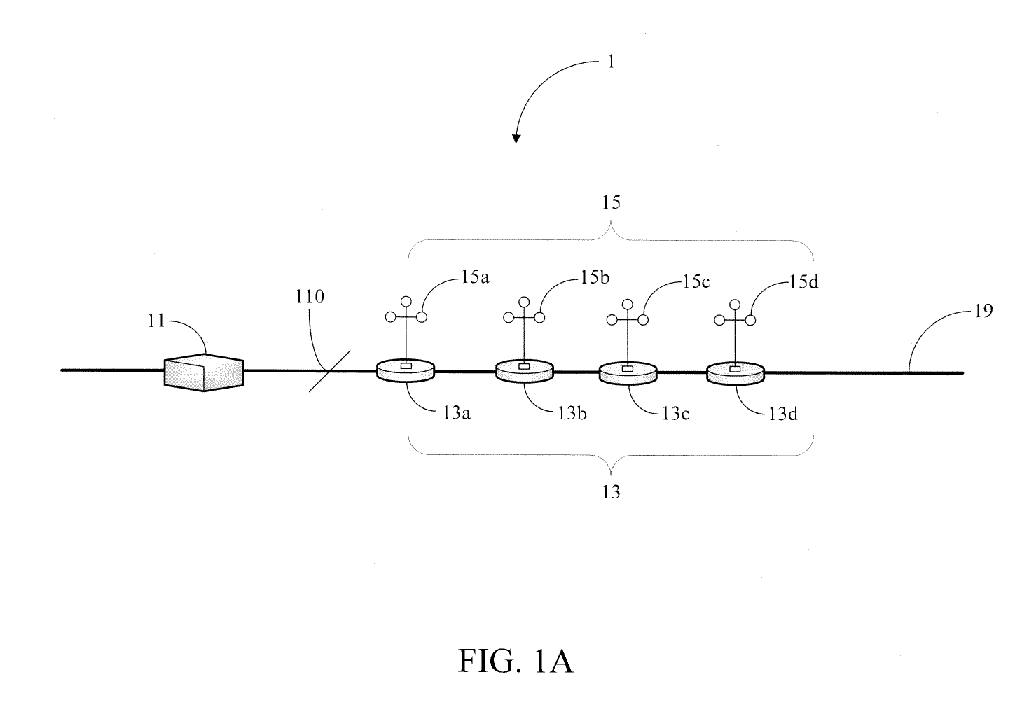

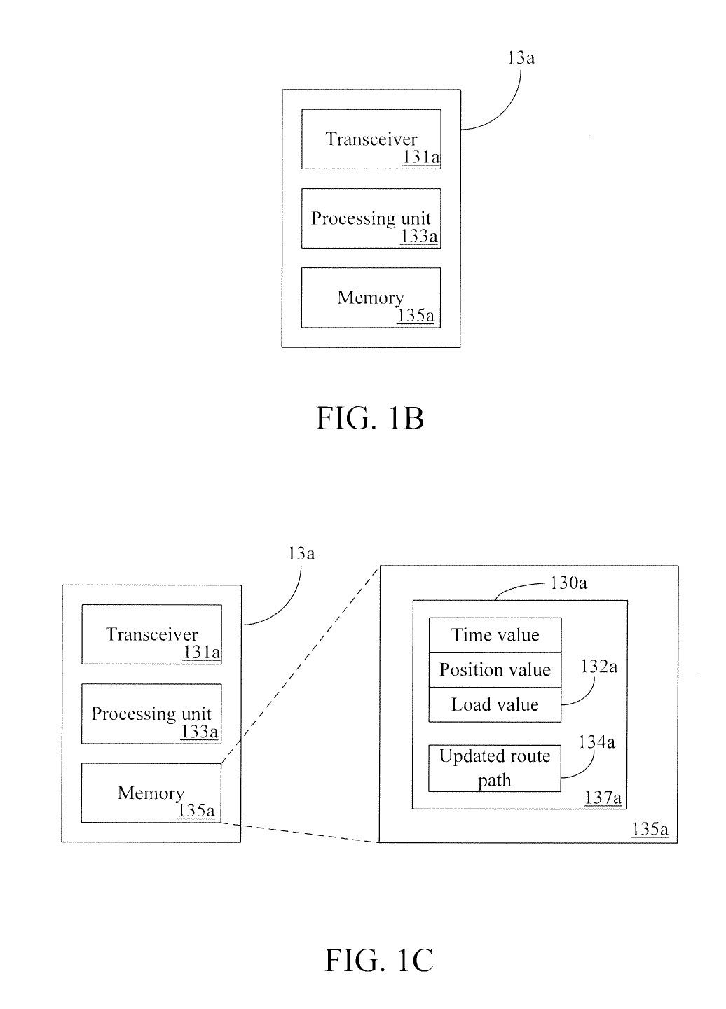

Referring to FIG. 1A, there is shown a schematic view of a power line communication (PLC) network 1 of a first embodiment of the present invention. The PLC network 1 comprises a gateway 11 and a plurality of network communication nodes 13. The gateway 11 and the network communication nodes 13 connect with each other mainly through a power line system 19 so that signals can be transmitted between the gateway 11 and the network communication nodes 13. It shall be particularly emphasized that, in the first embodiment, a street lamp system is introduced as an example of the PLC network 1, where the network communication nodes 13 are used to connect and control street lamps 15 and the street lamps 15 all have an initial OFF status. However, this is not intended to limit the present invention to a street lamp system, and those skilled in the art may readily apply the technical features of the present invention to various different PLC network systems.

Firstly, in the PLC network 1, the gateway 11 and the network communication nodes 13 establish a tree topology of route paths between individual network nodes through breadth-first search according to an initial load status of the network so as to transmit data according to the tree topology. Then, if the load of the PLC network 1 changes, the route path for data transmission will be changed correspondingly in a dynamic way.

Specifically, in the first embodiment, when the gateway 11 is to control the street lamps 15 connected to the network communication nodes 13, the gateway 11 broadcasts a broadcast instruction 110 in the PLC network 1 through the power line system 19. Then the broadcast instruction 110 is received by the network communication nodes 13 so that subsequent processing can be made. For example, if the gateway 11 is to turn on a street lamp 15d controlled by a network communication node 13d or is to check a voltage status of the street lamp 15d controlled by the network communication node 13d, the gateway 11 broadcasts a broadcast instruction 110 comprising a control instruction or a voltage and current query instruction (not shown) in the PLC network 1. Upon receiving the broadcast instruction 110 comprising the control instruction, the network communication node 13d turns on the street lamp 15d according to the broadcast instruction 110. Because the broadcast instruction 110 is transmitted by the gateway 1 in the PLC network 1 through broadcasting, the broadcast instruction 110 transmitted to the network communication node 13d by the gateway 11 can also be received by other network communication nodes 13a-13c.

Thus, in the way described above, all the network communication nodes 13 of the PLC network 1 can learn whether a load change occurs to any other network communication nodes in the network; in other words, the network communication nodes 13 can learn from the broadcast instruction 10 whether a load change occurs to the whole PLC network 1 and further determine whether noises caused by the changing load has an influence on the original route path for data transmission. Thus, the network communication nodes 13 can re-determine the route path for data transmission according to changes in the load. For example, in the first embodiment, as the street lamp 15d controlled by the network communication node 13d is turned on, an additional load arises in the PLC network 1. Noises generated by the additional load would have an influence on the transmission capability of the power line system 19, causing an interruption of the original route path that can connect the network communication node 13a directly to the network communication node 13d. Therefore, if the network communication node 13a desires to keep the communication route path with the network communication node 13d, the network communication node 13a must change the route path dynamically.

Refer to FIG. 1B and FIG. 1C together. FIG. 1B is a schematic view of the network communication node 13a according to the first embodiment of the present invention, and FIG. 1C is a schematic view of a route table 137a of the network communication node 13a. The network communication node 13a comprises a transceiver 131a, a processing unit 133a and a memory 135a. Functions of and interactions among individual hardware modules will be described in detail below. It shall be particularly emphasized that, the network communication nodes 13b-13d have the same hardware architecture as the network communication node 13a, and are respectively numbered herein just for convenience of subsequent description.

Specifically, the processing unit 133a of the network communication node 13a primarily determines a change 130a in the load of the PLC network 1 according to the broadcast instruction 110, and determines at least one updated route path 134a according to the load change. In more detail, the processing unit 133a of the network communication node 13a firstly determines a status characteristic value 132a of the network communication node 13a according to the change 130a in the load. In the first embodiment, the status characteristic value 132a comprises a time value, a position value and a load value; the time value is used to record a time point when the change 130a in the load occurs, the position value records a position of the network communication node 13a in the PLC network 1, and the load value records a power load status of the PLC network 1.

Next, the processing unit 133a of the network communication node 13a determines a current time, a position and a load status of the PLC network 1 according to the status characteristic value 132a and, from this, further determines whether a communication status between the network communication node 13a and neighboring nodes is good. In brief, the higher the load of the PLC network 1 as a whole is, the higher the noise suffered by the power line system 19 will be, and this has an influence on the signal transmission distance of the network communication node 13a; therefore, the communication status between the network communication node 13a and the neighboring nodes has to be re-measured to determine at least one updated route path 134a. It shall be particularly appreciated that, in the first embodiment of the present invention, the at least one updated route path 134a is determined by using a k nearest neighbor (KNN) algorithm according to the status characteristic value 132a. However, this is not intended to limit the present invention to that a new route path can only be calculated by using the KNN algorithm.

After determination of the at least one updated route path 134a, the transceiver 131a of the network communication node 13a transmits a communication data to another network communication node through the at least one updated route path 134a. In the first embodiment, the another network communication node may be the network communication node 13b or the network communication node 13c. Then, the processing unit 133a of the network communication node 13a records in the route table 137a of the memory 135a the status characteristic value 132a and the at least one updated route path 134a for use in subsequent data transmission and re-updating of the route path.

Thus, in the way described above, the network communication node 13 can dynamically change the route for data transmission according to the load change of the PLC network 1.

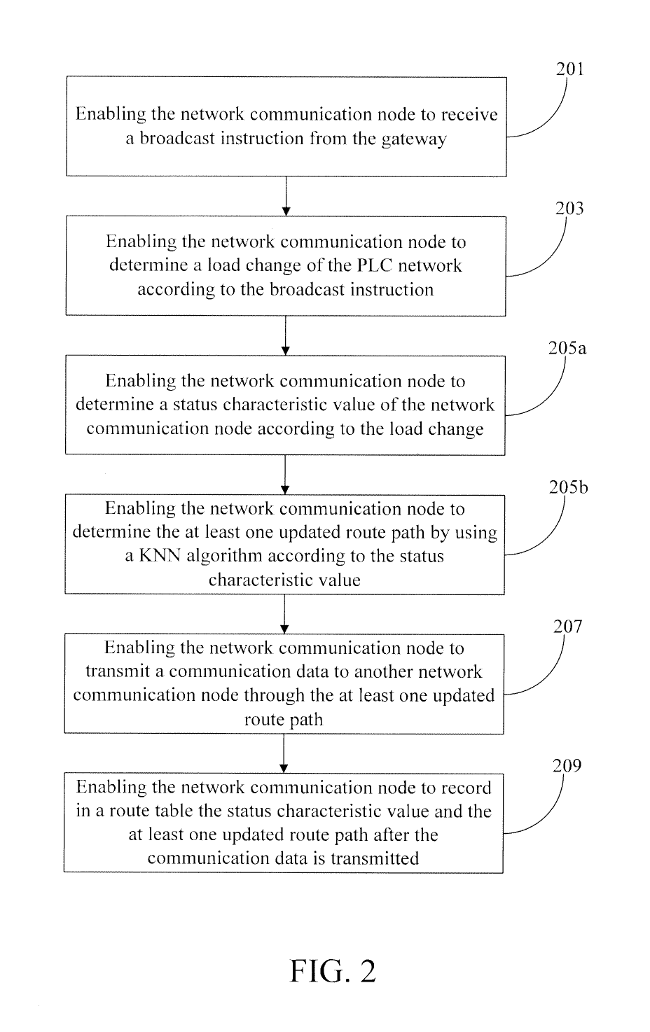

A second embodiment of the present invention is a data transmission method, a flowchart of which is shown in FIG. 2. The method of the second embodiment is for use in a network communication node (e.g., the network communication node 13 of the aforesaid embodiment). The network communication node is for use in a PLC network, which comprises a gateway and the network communication node. Detailed steps of the second embodiment will be described hereinbelow.

Step 201 is executed to enable the network communication node to receive a broadcast instruction from the gateway. Because the broadcast instruction is used to transmit a message to a certain node of the PLC network in a broadcasting way, all the nodes of the PLC network can learn content of the broadcast instruction. Accordingly, step 203 is executed to enable the network communication node to determine a load change of the PLC network according to the broadcast instruction. In detail, from the broadcast instruction, the network communication node can learn load usage conditions of other nodes in the PLC network so as to learn the load change of the PLC network as a whole.

Next, step 205 is executed to enable the network communication node to determine at least one updated route path according to the load change. In detail, the step 205 may be divided into two sub-steps. After sub-step 205a is executed, the network communication node determines a status characteristic value of the network communication node according to the load change. In the second embodiment, the status characteristic value comprises a time value, a position value and a load value. The time value is used to record a time point when the load change occurs, the position value records a position of the network communication node in the PLC network, and the load value records a power load status of the PLC network. Accordingly, after sub-step 205b is executed, the network communication node determines the at least one updated route path by using a KNN algorithm according to the status characteristic value.

Step 207 is executed to enable the network communication node to transmit a communication data to another network communication node through the at least one updated route path. Step 209 is executed to enable the network communication node to, after the communication data is transmitted, record in a route table the status characteristic value and the at least one updated route path for use in subsequent data transmission and re-updating of the route path.

According to the above descriptions, the network communication node and the data transmission method of the present invention can effectively determine whether the load of the PLC network changes; if the load changes “yes”, then the network communication node dynamically changes the route path for data transmission according to the change of the load. Thus, the data transmission in the PLC network can be accomplished correctly in an efficient way.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements arc not fully disclosed in the above descriptions, they have substantially been covered in the following claims as appended.

What is claimed is:

1. A data transmission method for a network communication node, the network communication node being for use in a power line communication (PLC) network, the PLC network comprising a gateway and the network communication node, and the gateway connecting to the network communication node through a power line system, the data transmission method comprising the following steps of:
(a) enabling the network communication node to receive a broadcast instruction from the gateway;
(b) enabling the network communication node to determine a load change of the PLC network according to the broadcast instruction;
(c) enabling the network communication node to determine at least one updated route path according to the load change; and
(d) enabling the network communication node to transmit a communication data to another network communication node through the at least one updated route path.

2. The data transmission method as claimed in claim 1, wherein the step (c) further comprises the following steps of:
(c1) enabling the network communication node to determine a status characteristic value of the network communication node according to the load change; and
(c2) enabling the network communication node to determine the at least one updated route path by using a k nearest neighbor (KNN) algorithm according to the status characteristic value.

3. The data transmission method as claimed in claim 2, wherein the status characteristic value comprises at least one of a time value, a position value and a load value.

4. The data transmission method as claimed in claim 2, further comprising the following step after step (d):
(e) enabling the network communication node to record the characteristic value and the at least one updated route path in a route table after the communication data is transmitted.

5. The data transmission method as claimed in claim 1, wherein the broadcast instruction comprises one of a control instruction and a voltage and current query instruction.

6. A network communication node for use in a power line communication (PLC) network, the PLC network comprising a gateway and the network communication node, and the gateway connecting to the network communication node through a power line system, the network communication node comprising:
a transceiver; and
a processing unit;
wherein the transceiver receives a broadcast instruction from the gateway, the processing unit determines a load change of the PLC network according to the broadcast instruction and determines at least one updated route path according to the load change, and the transceiver transmits a communication data to another network communication node through the at least one updated route path.

7. The network communication node as claimed in claim 6, wherein the processing unit is further configured to determine a status characteristic value of the network communication node according to the load change, and determine the at least one updated route path by using a k nearest neighbor (KNN) algorithm according to the status characteristic value.

8. The network communication node as claimed in claim 7, wherein the status characteristic value comprises at least one of a time value, a position value and a load value.

9. The network communication node as claimed in claim 7, further comprising:
a memory, being configured to record a route table;
wherein, after the transceiver transmits the communication data, the processing unit records the status characteristic value and the at least one updated route path in the route table of the memory.

10. The network communication node as claimed in claim 6, wherein the broadcast instruction comprises one of a control instruction and a voltage and current query instruction.
